(19) United States
(12) Patent Application Publication
(10) Pub. No.: US 2008/0165178 A1
(43) Pub. Date: Jul. 10, 2008

(54) Methods for adjusting the synchronization in digital display application

(75) Inventors: Cyrus Chu, Fremont, CA (US); Wen-Yi Huang, Donggang Township (TW)

Correspondence Address: BACON & THOMAS, PLLC, 625 SLATERS LANE, FOURTH FLOOR, ALEXANDRIA, VA, 22314, US

(73) Assignee: Terawins, Inc., Zhong-He City (TW)

(21) Appl. No.: 12/071,547

(22) Filed: Feb. 22, 2008

Related U.S. Application Data
(62) Division of application No. 11/092,938, filed on Mar. 30, 2005.

(51) Int. Cl. G09G 5/00

(52) U.S. Cl. 345/213

(57) ABSTRACT

The present invention is to provide two methods for trimming output HSync in display timing conversion for digital display application, so that the scaling controller can minimize Line Buffer timing shift and match the VSync/HSync timing requirement of digital display device. “Horizontal synchronization vibration” and “Remapping” are the two methods of the present invention.

### FIELD OF THE INVENTION

The present invention relates to methods for improving the synchronization in digital display application, and more particularly to horizontal synchronization vibration and remapping of the last horizontal synchronization line in digital display application.

### BACKGROUND OF THE INVENTION

As flat panel gets more popular, the image-scaling controller becomes more cost down and has more versatility for handling different input graphic timing to digital display devices.

Most of the scaler chips use Line Buffer structure instead of Frame Buffer structure, since Line Buffer structure can save more memory cost and chip pinout interface. Then how to minimize Line Buffer Size and keep acceptable scaling quality are the most important issues. However, less line buffer means it takes the risk of FIFO (first-in first-out) under-run or over-run when the relative timing between input graphic and output graphic is not precisely handled.

In general, for a given input graphic, V_ip_Active time (Vertical Input Active Time) must be equal to V_op_Active time (Vertical Output Active Time) in order to match the Line Buffer input write speed with the output read speed. However, the calculated HS_op_Total_dots (Horizontal output total dots) would not be an integer most of the time, therefore rounding HS_op_Total_dots to integer causes input active time not equal to output active time. In prior art, either a bigger Line Buffer size is kept to increase FIFO under-run/over-run tolerance or let the FIFO time in some input modes to be failed to handle.

FIG. 1 shows the timing waveform of Line Buffer under-run and over-run, in which VSi means “Vertical Sync input”, HDEi means “Horizontal Data Enable input”, VSo means “Vertical Sync output”, HDEo means “Horizontal Data Enable output”. During underrun, HDEo is too fast, while in overrun the HDEo is too slow, thus causing distortions.

Also, the calculated V_op_Total_lines (Vertical output total lines) is not an interger number after fixing output clock period and Hsync (Horizontal synchronization) period. The last fraction line will cause some panel displaying noises on the top of next screen.

### SUMMARY OF THE INVENTION

The primary objective of the present invention is to provide two methods for improving the synchronization in digital display application. In a digital display, the vertical timing is partitioned into four segments:

VSync_PulseTime (Vertical Synchronization Pulse Time),

VSync_BackPorch (Vertical Synchronization Back Porch),

V_Display_Active (Vertical Display Active), and

VSync_FrontPorch (Vertical Synchronization Front Porch),

In V_Display_Active period, a preset output clock (no relation to input clock) is used to calculate ideal HSync output total dots (mostly a non-integer number), then distribute its fraction dots to some other lines. This could make HSync period change a little, sometimes longer, sometimes shorter, but its average period equals to the ideal HSync period. This method makes the FIFO timing perfectly match and is called “horizontal synchronization vibration”.

The second method is called “remapping”. When the calculated “Vertical output total lines” is not an interger number, the “dots of last VSync fraction line” is distributed to all VSync_Front Porch (or to other non-V_Display_Active segments), so the Short/Long line issue can be easily removed.

### BRIEF DESCRIPTION OF THE DRAWINGS

FIG. 1 shows schematically the timing waveforms of line buffer during under-run and over-run.

FIG. 2 shows schematically a normally scaled image.

FIG. 3 shows schematically the line buffer under-run during scaling.

FIG. 4 shows schematically the line buffer over-run during scaling.

FIG. 5 shows schematically the output Hsync Vibration according to the present invention.

FIG. 6 shows schematically remapping of the last fraction line according to the present invention.

### DETAILED DESCRIPTION OF THE EMBODIMENTS

### Why Change Sync Timing?

A scaler for digital display device has to support different resolution graphic or video from many different sources, such as ADC and DVI input. We might have graphic in XGA, SXGA, UXGA or other format, each might have different VSync/HSync frequencies. For Video inputs (i.e. ITU-R656, ITU-R601, etc. . . . ), we might have different timing video inputs, such as NTSC, PAL, HDTV, . . . etc. Each of them has to be shrunk (scale down) or enlarged (scale up) to fit the fixed panel resolution.

A digital display device, such as LCD panel, based on its physical material, defines fixed active display region (resolution). It allows wide range VSync and HSync periods, and also accepts a little timing variation. However, if HSync timing changes a lot, e.g. more than 10% of previous period, the display device might generate unwanted image, such as a garbage white dots, shorter/delayed image line, or flicking, . . . etc. So, it is very important to keep HSync period as steady as possible.

For graphic scaling, it can save design cost if we keep output refresh rate (VSync frequency) equal to input refresh rate; this is also called “Frame-Lock”. The following 3-cases implement Scaler with buffers:

1. Scaler with Frame Buffer

Some Scalers are designed with Frame Buffers. They are embedded with DRAM or hooked to external DRAM to avoid this timing issue. However, the cost for such system and chip is very high.

2. Scaler with More Line Buffers

Some Scalers are designed with more Line Buffers, which has extra buffers to keep more FIFO guard band (distance between write pointers and read pointers), so that it can track Frame-Lock over few frames, i.e., it does not have to perform Frame-Lock in every frame, and accumulates the last fraction lines of each ideal frame to some other frames. Therefore, each output frame has integer HSync line (no short/long line). However, some frame may have 1 line more or 1 line less than other frames. This non-Frame-Lock design will cause the distance (time period) varies between the first write pointer and the first read pointer in each frame. Thus, it needs more Line Buffer guard band. This solution uses more on-chip SRAM blocks and usually has bigger chip size.

3. Scaler with Few Line Buffers

Some Scaler designs, based on chip cost consideration, may have very limited buffer guard band, so normally it has buffer under-run/over-run, short/long-line issues, or both.

### Line Buffer Under-run and Over-run

As Line Buffer is very small, if it is unable to maintain speed of buffer write-in and read-out, it is easy to have under-run or over-run issue.

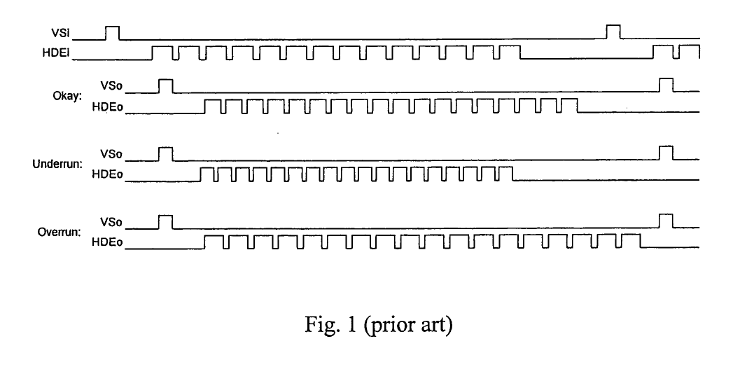

FIG. 1 shows the timing waveform of Line Buffer under-run and over-run, in which Vsi means “Vertical Sync Input”, HDEi means “Horizontal Data Enable input”, Vso means “Vertical Sync output”, HDEo means “Horizontal Data Enable output”. During underrun, HDEo is too fast, while in overrun the HDEo is too slow, thus causing distortions.

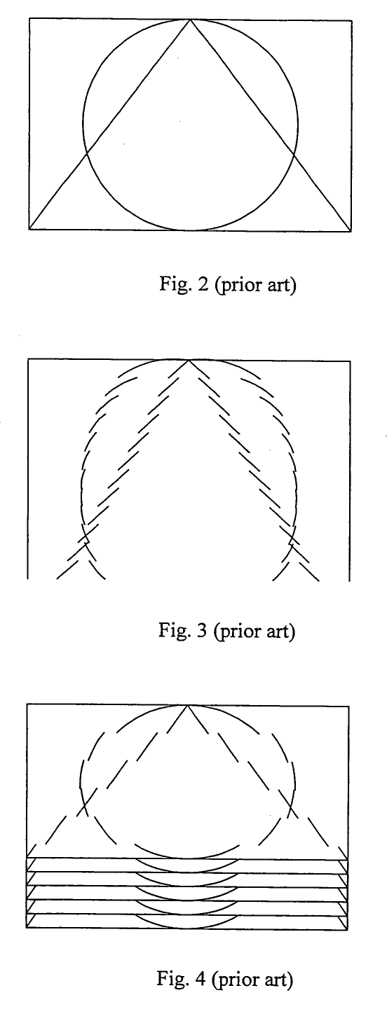

For an input image, if the line buffer maintains a correct speed, the output image will look like input image as shown in FIG. 2.

In under-run, the scaled image will duplicate some lines, and be unable to show the last input line. The output image will somewhat look like the graphic as shown in FIG. 3.

In over-run, the scaled image will lose some lines, and duplicate the last few input lines. The output image will somewhat look like the image as shown in FIG. 4.

However, besides carefully calculate output HSync Period, if the HSync period is allowed to be adjustable during active lines, it is possible to match exactly the same buffer speed, and then save the chip cost.

For ideal case, if the valid image range is selected to be scaled, say, input active image, the equation below has to be kept:

V_ip_Active time=V_op_Active time;

or precisely, in other way to express:

V_ip_Active (Line#)×HS_ip_Period (time) (HS means Hsync)=V_op_Active (Line#)×HS_op_Period (time); and

HS_op_Period (time)=CLK_op_period (time/dot)×HS_op_Total (dots);

So, HS_op_Total (dots)=(V_ip_Active (line#)×HS_ip_Period (time)/V_op_Active (line#))/CLK_op_period (time/dot);

However, it is 99% that this calculated HS op Total (dots) is not an integer, so the fraction portion of HS_op_Total (dots) for each output line will be accumulated during whole output V_op_Active period and to be a large number dots. Maybe it will exceed one line buffer, and cause under-run or over-run.

Therfore, we let the fraction portion of HS_op_Total (dots) to be distributed to some other lines to form HSync Vibration.

### HSync Vibration

The present invention, called “HSync Vibration in Vertical active region”, is implemented by the following procedures:

Let HS_op_Total (dots)_Base=Integer (HS_op_Total (dots));

and

HS_op_Total (dots)_Fraction=HS_op_Total (dots)_HSop_Total (dots)_Base;

For every time the next output line is displaying, calculate:

HS_op_Total (dots)_Vary:=Fraction (HS_op_Total (dots)_Vary)+HS_op_Total (dots)_Fraction;

If (HS_op_Total (dots)_Vary<1), then the current output line will have HS_op_Total (dots)=HS₁₃ op_Total (dots)_Base;
If (HS_op_Total (dots) Vary>=1), then the current output line will have HS_op_Total (dots)=HS_op_Total (dots)_Base+1.

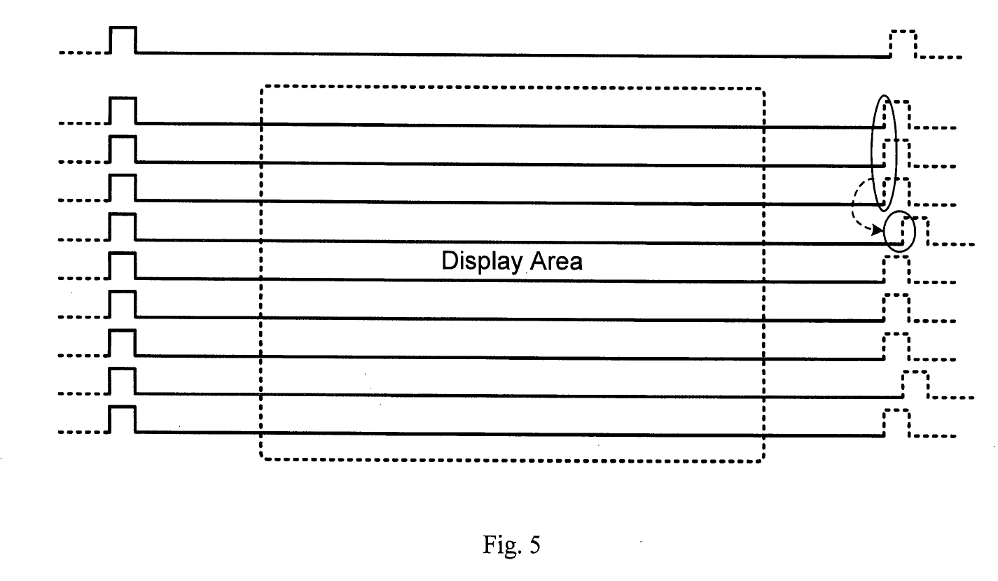

Thus, the variance can be self-adjust. This is shown in FIG. 5, in which the HS_op_Total (dots) will increase by “1” after three lines of “HS_op_Total (dots)_Base”.

For some high speed panel with dual channel output, the above equations can be slightly modified as below:

Let HS_op_Total (dots)_Base=Integer (HS_op_Total (dots)/2)×2;

and

HS_op_Total (dots)_Fraction=(HS_op_Total (dots)−HS_op_Total (dots)_Base)/2;

for every time the next output line is displaying, calculate:

HS_op_Total (dots) Vary:=Fraction (HS_op_Total (dots)_Vary)+HS_op_Total (dots)_Fraction;

If (HS_op_Total (dots)_Vary<1), then the current output line will have HS_op_Total (dots)=HS_op_Total (dots)_Base;
If (HS_op_Total (dots) Vary>=1), then the current output line will have HS_op_Total (dots)=HS_op_Total (dots)_Base+2.

### Remapping of the Last Display HSync Line

For a frame lock scaling system,

input frame time=output frame time

input frame time=V_ip_Total (line#)×H_ip_Total (dots)×Clock_ip_Period (time/dot);

output frame time=V_op_Total (line#)×H_op_Total (dots)×Clock_op_Period (time/dot);

For given Clock op_Period (time/dot) and H_op_Total (dots) (or after adjusted), calculate the V_op_Total (line#)=(V_ip_Total (line#)×H_ip_Total (dots)×Clock_ip_Period (time/dot))/(H_op_Total (dots)×Clock_op_Period (time/dot)).

Unfortunately, the calculated V_op_Total (line#) is also 99% non-integer.

Some panels cannot accept that the last fraction line is less than 90% duration of the previous line. So, current solution is optional to remove last fraction line by disable last output HSync pulse; or try to adjust output clock or output HSync period.

The present invention is to remap the last fraction line to other non-active output lines, so that some output HSync lines may have more dots, but still in the HSync vary tolerance (normally, 10% variance range) of panels.

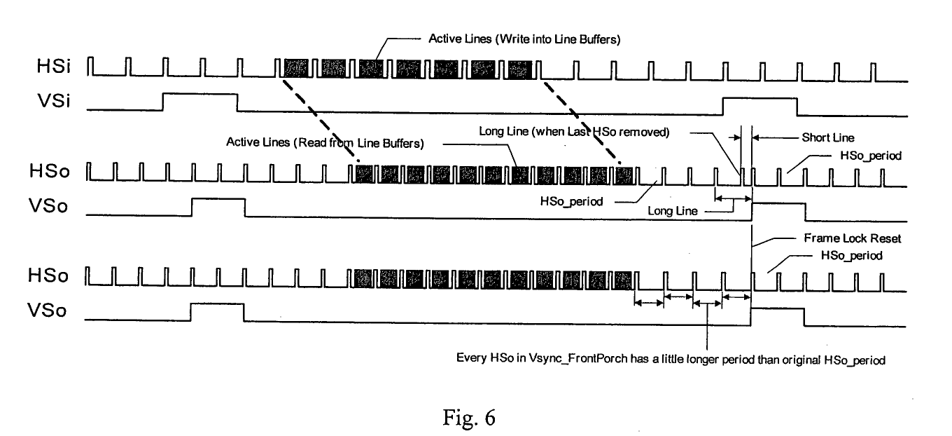

The drawing in FIG. 6 is about the short line/long line issue, and the remapped result. The last fraction line is a short line, which will cause problem that when the next VSo is coming, the HSo will delay a little time. If the HSo of the last fraction line is omitted, a long line is obtained, which might cause digital panel's failure to track output HS period, and might generate unwanted image, such as garbage white dots, shorter/delayed image line, or flicking, . . . etc.

Therefore, the present invention provides a method to distribute the dots in the last fraction line to the previous several lines. The previous several lines are in the VSync_FrontPorch segment as shown in FIG. 6.

Additional dots of each remapped lines=Roundup of [(Dots of last fraction line)/(number of the remapped output lines)] ∘Roundup means that fraction part will be omitted and let the integer part to be increased by “1”.

To well distribute those dots of last fraction line, it is better to have more remapped output lines. It can be whole output lines if there is no line buffer under-run/overrun issue, or it can be non-Active lines or just the vertical front porch lines.

The spirit and scope of the present invention depend only upon the following Claims, and are not limited by the above embodiments.

1. A method for adjusting the synchronization in digital display application, in a digital display, the vertical timing is partitioned into four segments: VSync_PulseTime (Vertical Synchronization Pulse Time), VSync_BackPorch (Vertical Synchronization Back Porch), V_Display_Active (Vertical Display Active), and VSync_FrontPorch (Vertical Synchronization Front Porch);
wherein a preset output clock and a Horizontal Sync Output Total Dots is used to calculate a Vertical output Total lines, an integer part of the calculation is used as the Vertical output Total lines, while a fraction part of the calculation can be recalculated into a Dots of last fraction line by the Horizontal Sync Output Total Dots, then remap the Dots of last fraction line to previous output line buffers.

2. The method for adjusting the synchronization in digital display application according to claim 1, wherein the Dots of last fraction line is remapped to VSync_FrontPorch segment or to other non-V-Display_Active segments.

3. The method for adjusting the synchronization in digital display application according to claim 1, wherein additional dots of each remapped line buffers is a Roundup of [(Dots of last fraction line)/(number of the remapped output line buffers)].
